(19) United States
(12) Patent Application Publication
(10) Pub. No.: US 2023/0354380 A1
(43) Pub. Date: Nov. 2, 2023

(54) INTER-OPERATOR MULTICAST AND UNICAST CONVERGENCE TRANSMISSION

(71) Applicant: QUALCOMM Incorporated, San Diego, CA (US)

(72) Inventors: Yiqing CAO, Beijing (CN); Yan LI, Beijing (CN); Thomas STOCKHAMMER, Bergen (DE); Zhimin DU, Beijing (CN)

(21) Appl. No.: 17/997,895

(22) PCT Filed: Apr. 3, 2020
(86) PCT No.: PCT/CN2020/083128

§ 371 Date: Nov. 3, 2022

(51) Int. Cl. H04W 72/30; H04W 72/12

(52) U.S. Cl. CPC H04W 72/30; H04W 72/12

(57) ABSTRACT

Various aspects of the present disclosure generally relate to wireless communication. In some aspects, a user equipment may receive, from a first base station associated with a first operator, a broadcast transmission conveying a first portion of a communication; and may receive, without triggering a retransmission of the broadcast transmission, a second portion of the communication via a unicast transmission from a second base station associated with a second operator. Numerous other aspects are provided.

### FIELD OF THE DISCLOSURE

Aspects of the present disclosure generally relate to wireless communication and to techniques and apparatuses for inter-operator multicast and unicast convergence transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include receiving, from a first base station associated with a first operator, a broadcast transmission conveying a first portion of a communication, and receiving, without triggering a retransmission of the broadcast transmission, a second portion of the communication via a unicast transmission from a second base station associated with a second operator.

In some aspects, a UE for wireless communication may include memory and one or more processors coupled to the memory. The memory and the one or more processors may be configured to receive, from a first base station associated with a first operator, a broadcast transmission conveying a first portion of a communication, and receive, without triggering a retransmission of the broadcast transmission, a second portion of the communication via a unicast transmission from a second base station associated with a second operator.

In some aspects, a non-transitory computer-readable medium may store one or more instructions for wireless communication. The one or more instructions, when executed by one or more processors of a UE, may cause the one or more processors to receive, from a first base station associated with a first operator, a broadcast transmission conveying a first portion of a communication, and receive, without triggering a retransmission of the broadcast transmission, a second portion of the communication via a unicast transmission from a second base station associated with a second operator.

In some aspects, an apparatus for wireless communication may include means for receiving, from a first base station associated with a first operator, a broadcast transmission conveying a first portion of a communication, and means for receiving, without triggering a retransmission of the broadcast transmission, a second portion of the communication via a unicast transmission from a second base station associated with a second operator.

In some aspects, a method of wireless communication, performed by a base station, may include receiving, from a UE that received a first portion of a communication from a first base station associated with a first operator via a broadcast transmission, information indicating a failure of the broadcast transmission, and providing, without triggering a retransmission of the broadcast transmission, a second portion of the communication via a unicast transmission.

In some aspects, a base station for wireless communication may include memory and one or more processors coupled to the memory. The memory and the one or more processors may be configured to receive, from a user equipment (UE) that received a first portion of a communication from a first base station associated with a first operator via a broadcast transmission, information indicating a failure of the broadcast transmission, and provide, without triggering a retransmission of the broadcast transmission, a second portion of the communication via a unicast transmission.

In some aspects, a non-transitory computer-readable medium may store one or more instructions for wireless communication. The one or more instructions, when executed by one or more processors of a base station, may cause the one or more processors to receive, from a UE that received a first portion of a communication from a first base station associated with a first operator via a broadcast transmission, information indicating a failure of the broadcast transmission, and provide, without triggering a retransmission of the broadcast transmission, a second portion of the communication via a unicast transmission.

In some aspects, an apparatus for wireless communication may include means for receiving, from a UE that received a first portion of a communication from a first base station associated with a first operator via a broadcast transmission, information indicating a failure of the broadcast transmission, and means for providing, without triggering a retransmission of the broadcast transmission, a second portion of the communication via a unicast transmission.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIGS. 3A and 3B are diagrams illustrating an example of inter-operator multicast and unicast convergence transmission, in accordance with various aspects of the present disclosure.

FIG. 4 is a diagram illustrating an example process performed, for example, by a user equipment, in accordance with various aspects of the present disclosure.

FIG. 5 is a diagram illustrating an example process performed, for example, by a base station, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

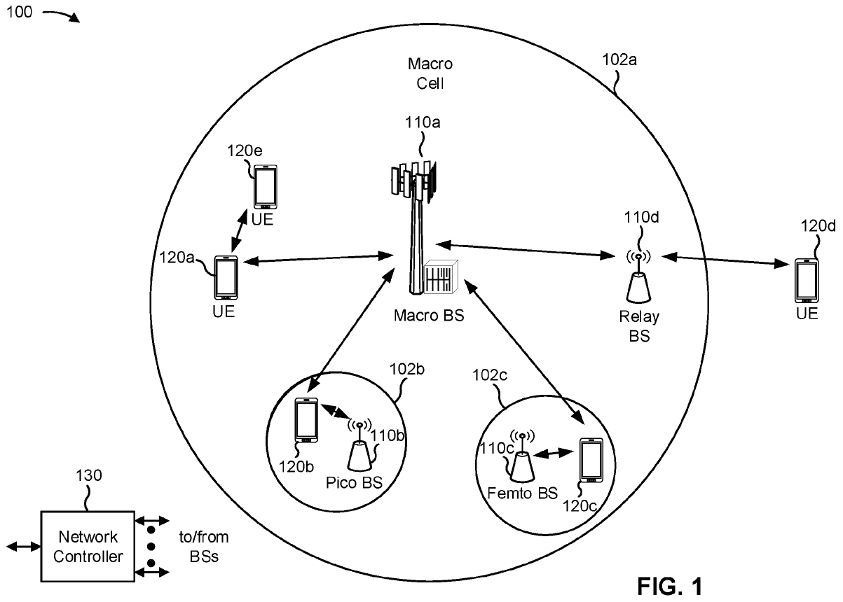

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as narrowband IoT (NB-IoT) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

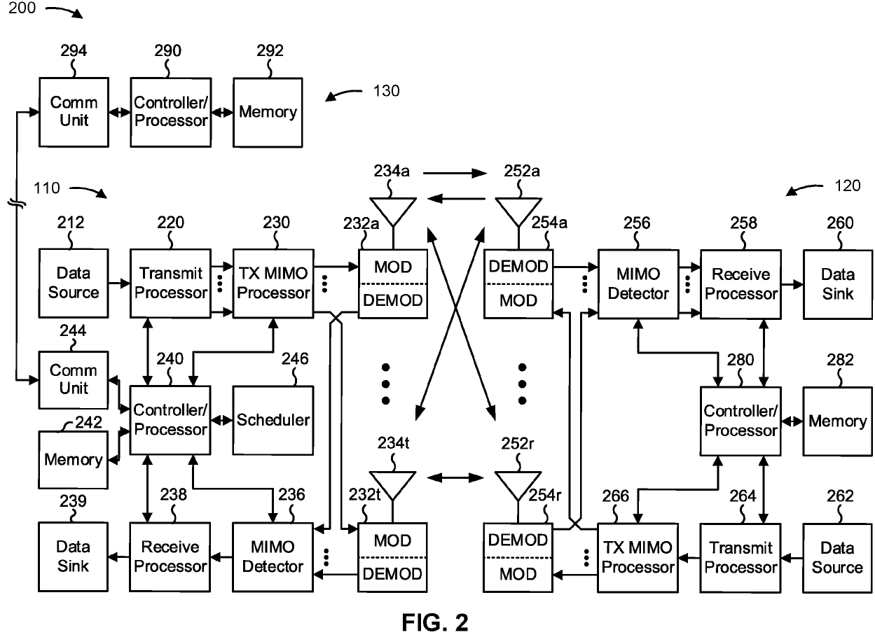

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T ≥ 1 and R ≥ 1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

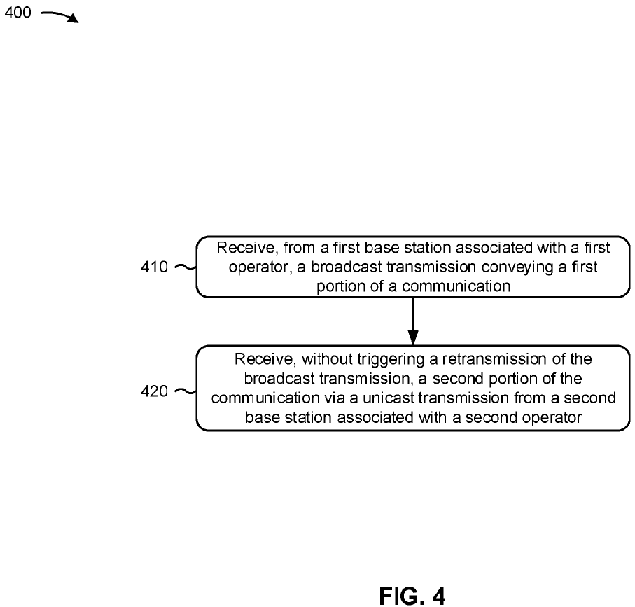

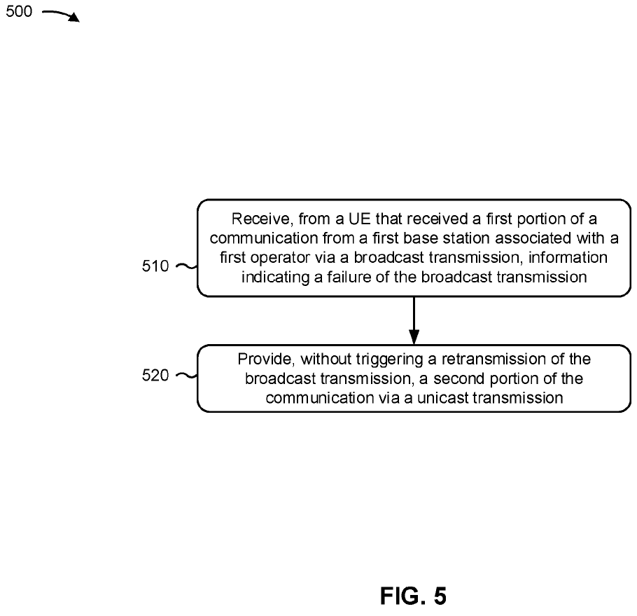

Controller/processor 240 of base station 110, controller/processor 280 of UE 120, and/or any other component(s) of FIG. 2 may perform one or more techniques associated with inter-operator multicast and unicast convergence transmission, as described in more detail elsewhere herein. For example, controller/processor 240 of base station 110, controller/processor 280 of UE 120, and/or any other component(s) of FIG. 2 may perform or direct operations of, for example, process 400 of FIG. 4, process 500 of FIG. 5, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed (e.g., directly, or after compiling, converting, interpreting, and/or the like) by one or more processors of the base station 110 and/or the UE 120, may perform or direct operations of, for example, process 400 of FIG. 4, process 500 of FIG. 5, and/or other processes as described herein. In some aspects, executing instructions may include running the instructions, converting the instructions, compiling the instructions, interpreting the instructions, and/or the like. A scheduler 246 may schedule UEs for data transmission on the downlink and/or uplink.

In some aspects, a UE 120 may include means for receiving, from a first base station associated with a first operator, a broadcast transmission conveying a first portion of a communication, means for receiving, without triggering a retransmission of the broadcast transmission, a second portion of the communication via a unicast transmission from a second base station associated with a second operator, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, a base station 110 may include means for receiving, from a user equipment that received a first portion of a communication from a first base station associated with a first operator via a broadcast transmission, information indicating a failure of the broadcast transmission, means for providing, without triggering a retransmission of the broadcast transmission, a second portion of the communication via a unicast transmission, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

In some communications systems, unicast and broadcast services may be deployed using a convergence architecture. In a convergence architecture, a UE may access unicast transmissions (e.g., data service, calling, and/or the like) via a first cell and broadcast transmissions (e.g., streaming media, public service announcements, and/or the like) via a second cell. In this case, the first cell and the second cell may be deployed to at least partially overlap so that the UE can access each cell depending on which information the UE is to receive (e.g., the UE may access the first cell for data service and the second cell for streaming media, such as television broadcasting). The first cell and the second cell may be operated by a single operator, thereby providing coordination between UE access to each cell.

However, some operators may deploy broadcast networks that provide subscription-less access. For example, a UE may receive broadcast transmissions on a broadcast network, of a first operator, to which the UE is not subscribed, thereby enabling dissemination of public service announcements, television as a public-service, and/or other broadcast content. In this case, the UE may subscribe to a unicast network operated by a second operator to communicate on a unicast connection (e.g., for data service, calling service, and/or the like). For single operator deployments, when a failure occurs with a broadcast transmission of a communication on a broadcast network, the UE may use multicast operation on demand (MOOD) procedures to fall back to receiving the communication on via unicast transmission. However, for multi-operator deployments (e.g., where different operators provide a broadcast link and a unicast link that a UE is using), the UE may request application layer retransmission via a unicast link, which may result in excessive latency to resume receiving streaming content.

Some aspects described herein provide inter-operator multicast and unicast convergence transmission For example, a UE may detect a failure of a broadcast transmission associated with a first operator and may transmit information identifying a packet at which the failure of the broadcast transmission occurs. In this way, the UE enables a BS of a unicast network associated with a second operator to start unicast transmission of streaming content dropped as a result of the failure of the broadcast transmission. Based at least in part on providing the information identifying the packet at which the failure occurs, the UE may reduce a latency associated with resuming transmission of the streaming content relative to requesting application layer retransmission, thereby reducing an interruption to content streaming and improving UE performance.

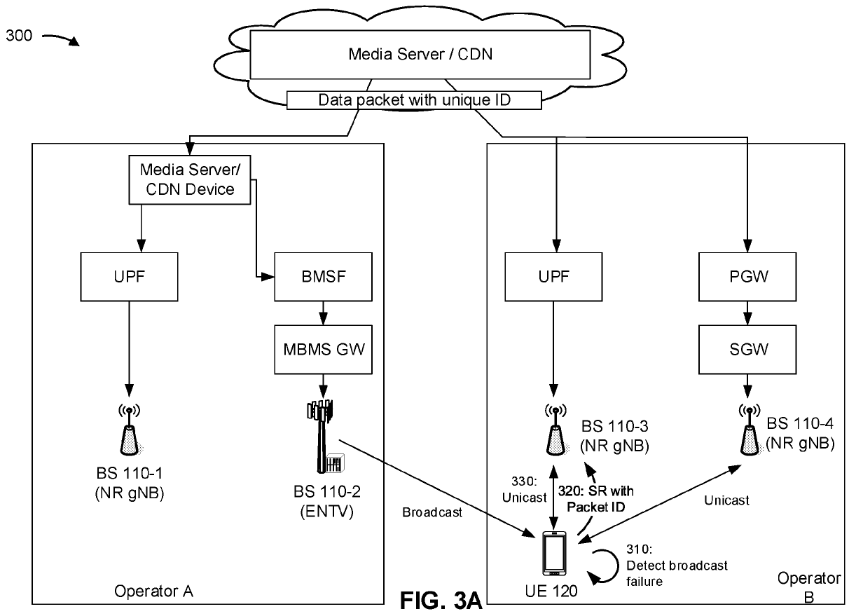

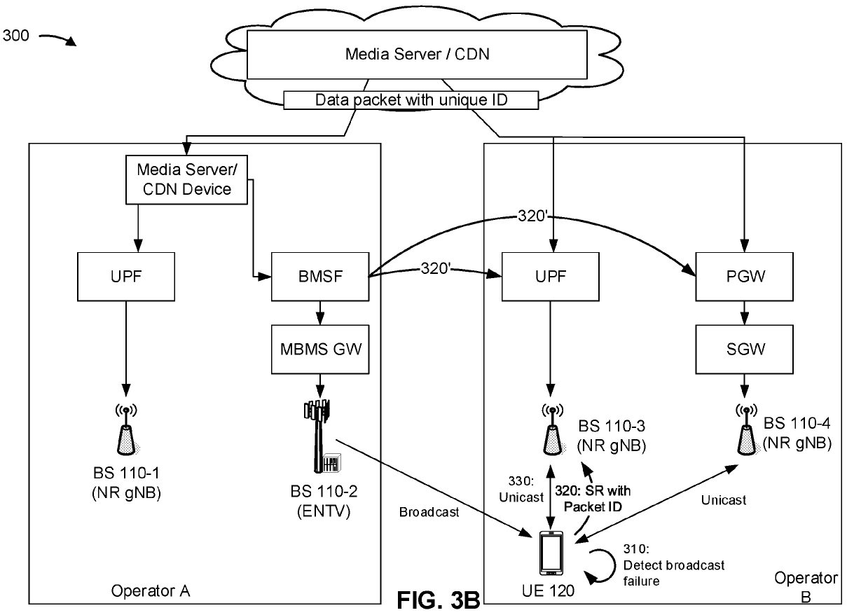

FIGS. 3A and 3B are diagrams illustrating examples 300/300′ of inter-operator multicast and unicast convergence transmission, in accordance with various aspects of the present disclosure.

As shown in FIG. 3A, and by example 300, a first operator (Operator A) may be associated with a first set of network devices, such as a media server or content delivery network (CDN) device, a user-plane function (UPF), a unicast BS 110-1 (e.g., an NR gNB that provides unicast coverage to subscribed devices), a broadcast multicast service function (BMSF), a multimedia broadcast multicast service (MBMS) gateway (GW), a broadcast BS 110-2 (e.g., an enhancement for TV service (ENTV) BS that provides broadcast coverage to subscribed devices and non-subscribed devices), and/or the like. Additionally, or alternatively, a second operator (Operator B) may be associated with a second set of network devices, such as a UPF, a third BS 110-3 (e.g., an NR gNB providing unicast coverage to subscribed devices), a packet data network gateway (PGW), a serving gateway (SGW), a fourth BS 110-4 (e.g., an LTE eNB providing unicast coverage to subscribed devices), and/or the like.

As further shown in FIG. 3A, and by reference number 310, after receiving a first portion of a communication via a broadcast transmission from BS 110-2, UE 120 may detect a broadcast failure. For example, UE 120 may determine that a measurement of the broadcast transmission does not satisfy a threshold and may determine that the broadcast transmission satisfies a failure condition. In some aspects, the threshold may be a pre-defined or network configured threshold. In some aspects, UE 120 may determine that the failure condition is satisfied based at least in part on the measurement of the broadcast transmission failing to satisfy a threshold for a period of time. For example, UE 120 may perform a plurality of measurements of the broadcast transmission during a configured period of time and may determine that the failure condition is satisfied based at least in part on the plurality of measurements failing to satisfy the threshold. In some aspects, the threshold may be a threshold related to a reference signal received power (RSRP), a reference signal received quality (RSRQ), a block error rate (BLER), a signal to interference and noise ratio (SINR), and/or the like.

As further shown in FIG. 3A, and by reference number 320, UE 120 may transmit information indicating that a failure of the broadcast transmission has occurred. For example, UE 120 may transmit a scheduling request (SR) indicating that the broadcast transmission has occurred and configuring a resumption of transmission of the communication via a unicast transmission on a network of operator B to which UE 120 is subscribed. In this case, UE 120 may provide information identifying a packet at which the broadcast transmission failed. For example, each packet that UE 120 receives from the broadcast transmission may include a unique identifier, and UE 120 may provide information identifying the unique identifier to BS 110-3 (as shown) to enable BS 110-3 to resume transmission of the communication via unicast transmission. In another example, UE 120 may provide information to BS 110-4 to enable BS 110-4 to resume transmission via unicast transmission. In some aspects, the media server or CDN device may divide streaming content into a plurality of packets (e.g., using a communication protocol, such as common media application format (CMAF)) and may assign identifiers to each of the plurality of packets (e.g., in a packet header or as a portion of a packet payload). When UE 120 receives a packet from BS 110-2, UE 120 may determine a packet identifier for the packet to enable UE 120 to report the packet identifier to, for example, BS 110-3 to enable resumption of transmission.

In some aspects, BS 110-3 may fetch communication (e.g., the packet at which the broadcast transmission failed, a next packet after the packet at which the broadcast transmission failed, and/or the like) from a media server or CDN device that is providing the communication to both operator A and operator B. In contrast, as shown in FIG. 3B, when devices of operator B have a connection to the broadcast multicast service function of operator A, BS 110-3 may obtain the communication directly from the broadcast multicast service function rather than from the media server or CDN device.

As further shown in FIG. 3A, and by reference number 330, based at least in part on UE 120 reporting the failure of the broadcast transmission, BS 110-3 may set up a unicast transmission and provide a second portion of the communication via the unicast transmission. For example, BS 110-3 may provide the communication starting from a packet at which a failure of the broadcast transmission occurs, a next packet after the packet at which the failure of the broadcast transmission occurs, and/or the like. In some aspects, BS 110-3 may detect a unicast connection setup failure when attempting to set up a unicast connection. In this case, BS 110-3 may resume transmission of the communication (e.g., via unicast transmission) from another packet (e.g., a packet included in the first portion resulting in an overlap between the first portion and the second portion, a packet not included in the first portion resulting in disjoint portions, and/or the like). In this way, UE 120 and BS 110-3 enable continuation of a communication after a broadcast transmission failure without triggering a retransmission of the communication, thereby reducing latency to complete the communication.

As indicated above, FIGS. 3A and 3B are provided as an example. Other examples may differ from what is described with respect to FIGS. 3A and 3B.

FIG. 4 is a diagram illustrating an example process 400 performed, for example, by a UE, in accordance with various aspects of the present disclosure. Example process 400 is an example where a UE (e.g., UE 120) performs inter-operator multicast and unicast convergence transmission.

As shown in FIG. 4, in some aspects, process 400 may include receiving, from a first base station associated with a first operator, a broadcast transmission conveying a first portion of a communication (block 410). For example, the UE (e.g., using antenna 252, DEMOD 254, MIMO detector 256, receive processor 258, controller/processor 280, and/or the like) may receive, from a first base station associated with a first operator, a broadcast transmission conveying a first portion of a communication, as described above.

As shown in FIG. 4, in some aspects, process 400 may include receiving, without triggering a retransmission of the broadcast transmission, a second portion of the communication via a unicast transmission from a second base station associated with a second operator (block 420). For example, the UE (e.g., using antenna 252, DEMOD 254, MIMO detector 256, receive processor 258, controller/processor 280, and/or the like) may receive, without triggering a retransmission of the broadcast transmission, a second portion of the communication via a unicast transmission from a second base station associated with a second operator, as described above.

Process 400 may include additional aspects, such as any single aspect and/or any combination of aspects described below and/or in connection with one or more other processes described elsewhere herein.

In a first aspect, process 400 includes detecting a failure of the broadcast transmission and transmitting, to the second base station, a scheduling request to trigger an initialization of a unicast link on which the unicast transmission is conveyed.

In a second aspect, alone or in combination with the first aspect, the scheduling request includes information identifying a unique packet identifier associated with the communication.

In a third aspect, alone or in combination with one or more of the first and second aspects, the second portion of the communication starts from a first missing packet after a failure of the broadcast transmission.

In a fourth aspect, alone or in combination with one or more of the first through third aspects, the second portion of the communication starts from a next packet after a first missing packet after a failure of the broadcast transmission.

In a fifth aspect, alone or in combination with one or more of the first through fourth aspects, process 400 includes determining that a measurement of the broadcast transmission does not satisfy a threshold, and identifying a failure of the broadcast transmission based at least in part on determining that the measurement of the broadcast transmission does not satisfy the threshold; and receiving the second portion of the communication via the unicast transmission includes receiving the second portion of the communication via the unicast transmission based at least in part on identifying the failure of the broadcast transmission

In a sixth aspect, alone or in combination with one or more of the first through fifth aspects, the communication includes a plurality of parts divided based at least in part on a communication protocol, and each part includes an identifier.

In a seventh aspect, alone or in combination with one or more of the first through sixth aspects, process 400 includes transmitting information identifying an identifier of a part of the plurality of parts to indicate where the second portion of the communication is to start.

In an eighth aspect, alone or in combination with one or more of the first through seventh aspects, process 400 includes detecting a setup failure for a unicast link on which the unicast transmission is to be conveyed, and receiving the second portion of the communication via the unicast link after the setup failure, wherein the second portion of the communication at least partially overlaps with the first portion of the communication.

In a ninth aspect, alone or in combination with one or more of the first through eighth aspects, process 400 includes detecting a setup failure for a unicast link on which the unicast transmission is to be conveyed, and receiving the second portion of the communication via the unicast link after the setup failure, wherein the second portion of the communication is disjoint from the first portion of the communication.

In a tenth aspect, alone or in combination with one or more of the first through ninth aspects, the second portion of the communication is received from the second base station via a broadcast multicast service function.

In an eleventh aspect, alone or in combination with one or more of the first through tenth aspects, the first operator and the second operator share a connection on a core network.

In a twelfth aspect, alone or in combination with one or more of the first through eleventh aspects, the communication is received from a content delivery network via at least one of the first base station or the second base station.

In a thirteenth aspect, alone or in combination with one or more of the first through twelfth aspects, the UE is subscribed to the second operator and not subscribed to the first operator.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by a BS, in accordance with various aspects of the present disclosure. Example process 500 is an example where a second BS (e.g., BS 110-3) performs inter-operator multicast and unicast convergence transmission.

As shown in FIG. 5, in some aspects, process 500 may include receiving, from a UE that received a first portion of a communication from a first base station associated with a first operator via a broadcast transmission, information indicating a failure of the broadcast transmission (block 510). For example, the second BS (e.g., using antenna 234, DEMOD 232, MIMO detector 236, receive processor 238, controller/processor 240, and/or the like) may receive, from a UE that received a first portion of a communication from a first base station associated with a first operator via a broadcast transmission, information indicating a failure of the broadcast transmission, as described above.

As shown in FIG. 5, in some aspects, process 500 may include providing, without triggering a retransmission of the broadcast transmission, a second portion of the communication via a unicast transmission (block 520). For example, the second BS (e.g., using controller/processor 240, transmit processor 220, TX MIMO processor 230, MOD 232, antenna 234, and/or the like) may provide, without triggering a retransmission of the broadcast transmission, a second portion of the communication via a unicast transmission, as described above.

Process 500 may include additional aspects, such as any single aspect and/or any combination of aspects described below and/or in connection with one or more other processes described elsewhere herein.

In a first aspect, receiving the information indicating the failure of the broadcast transmission includes receiving a scheduling request to trigger an initialization of a unicast link on which the unicast transmission is conveyed.

In a second aspect, alone or in combination with the first aspect, the scheduling request includes information identifying a unique packet identifier associated with the communication.

In a third aspect, alone or in combination with one or more of the first and second aspects, the second portion of the communication starts from a first missing packet after a failure of the broadcast transmission.

In a fourth aspect, alone or in combination with one or more of the first through third aspects, the second portion of the communication starts from a next packet after a first missing packet after a failure of the broadcast transmission.

In a fifth aspect, alone or in combination with one or more of the first through fourth aspects, the communication comprises a plurality of parts divided based at least in part on a communication protocol, and each part includes an identifier.

In a sixth aspect, alone or in combination with one or more of the first through fifth aspects, receiving the information indicating the failure of the broadcast transmission includes receiving information identifying an identifier of a part of the plurality of parts to indicate where the second portion of the communication is to start.

In a seventh aspect, alone or in combination with one or more of the first through sixth aspects, process 500 includes detecting a setup failure for a unicast link on which the unicast transmission is to be conveyed and transmitting the second portion of the communication via the unicast link after the setup failure, wherein the second portion of the communication at least partially overlaps with the first portion of the communication.

In an eighth aspect, alone or in combination with one or more of the first through seventh aspects, process 500 includes detecting a setup failure for a unicast link on which the unicast transmission is to be conveyed and receiving the second portion of the communication via the unicast link after the setup failure, wherein the second portion of the communication is disjoint from the first portion of the communication.

In a ninth aspect, alone or in combination with one or more of the first through eighth aspects, process 500 includes obtaining the second portion of the communication from a broadcast multicast service center.

In a tenth aspect, alone or in combination with one or more of the first through ninth aspects, the first operator and the second operator share a connection on a core network.

In an eleventh aspect, alone or in combination with one or more of the first through tenth aspects, process 500 includes obtaining the communication from a content delivery network.

In a twelfth aspect, alone or in combination with one or more of the first through eleventh aspects, the UE is subscribed to the second operator and not subscribed to the first operator.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
receiving, from a first base station associated with a first operator, a broadcast transmission conveying a first portion of a communication; and
receiving, without triggering a retransmission of the broadcast transmission, a second portion of the communication via a unicast transmission from a second base station associated with a second operator.

2. The method of claim 1, further comprising:
detecting a failure of the broadcast transmission; and
transmitting, to the second base station, a scheduling request to trigger an initialization of a unicast link on which the unicast transmission is conveyed.

3. The method of claim 2, wherein the scheduling request includes information identifying a unique packet identifier associated with the communication.

4. The method of claim 2, wherein the second portion of the communication starts from a first missing packet after a failure of the broadcast transmission.

5. The method of claim 2, wherein the second portion of the communication starts from a next packet after a first missing packet after a failure of the broadcast transmission.

6. The method of claim 1, further comprising:
determining that a measurement of the broadcast transmission does not satisfy a threshold;
identifying a failure of the broadcast transmission based at least in part on determining that the measurement of the broadcast transmission does not satisfy the threshold; and
wherein receiving the second portion of the communication via the unicast transmission comprises:
receiving the second portion of the communication via the unicast transmission based at least in part on identifying the failure of the broadcast transmission.

7. The method of claim 1, wherein the communication comprises a plurality of parts divided based at least in part on a communication protocol, and wherein each part includes an identifier.

8. The method of claim 7, further comprising:
transmitting information identifying an identifier of a part of the plurality of parts to indicate where the second portion of the communication is to start.

9. The method of claim 1, further comprising:
detecting a setup failure for a unicast link on which the unicast transmission is to be conveyed; and
receiving the second portion of the communication via the unicast link after the setup failure, wherein the second portion of the communication at least partially overlaps with the first portion of the communication.

10. The method of claim 1, further comprising:
detecting a setup failure for a unicast link on which the unicast transmission is to be conveyed; and
receiving the second portion of the communication via the unicast link after the setup failure, wherein the second portion of the communication is disjoint from the first portion of the communication.

11. The method of claim 1, wherein the second portion of the communication is received from the second base station via a broadcast multicast service function.

12. The method of claim 1, wherein the first operator and the second operator share a connection on a core network.

13. The method of claim 1, wherein the communication is received from a content delivery network via at least one of the first base station or the second base station.

14. The method of claim 1, wherein the UE is subscribed to the second operator and not subscribed to the first operator.

15. A method for wireless communication performed by a second base station associated with a second operator, comprising:
receiving, from a user equipment (UE) that received a first portion of a communication from a first base station associated with a first operator via a broadcast transmission, information indicating a failure of the broadcast transmission; and
providing, without triggering a retransmission of the broadcast transmission, a second portion of the communication via a unicast transmission.

16. The method of claim 15, wherein receiving the information indicating the failure of the broadcast transmission comprises:
receiving a scheduling request to trigger an initialization of a unicast link on which the unicast transmission is conveyed.

17. The method of claim 16, wherein the scheduling request includes information identifying a unique packet identifier associated with the communication.

18. The method of claim 16, wherein the second portion of the communication starts from a first missing packet after a failure of the broadcast transmission.

19. The method of claim 16, wherein the second portion of the communication starts from a next packet after a first missing packet after a failure of the broadcast transmission.

20. The method of claim 15, wherein the communication comprises a plurality of parts divided based at least in part on a communication protocol, and
wherein each part includes an identifier.

21. The method of claim 20, wherein receiving the information indicating the failure of the broadcast transmission comprises:
receiving information identifying an identifier of a part of the plurality of parts to indicate where the second portion of the communication is to start.

22. The method of claim 15, further comprising:
detecting a setup failure for a unicast link on which the unicast transmission is to be conveyed; and
transmitting the second portion of the communication via the unicast link after the setup failure, wherein the second portion of the communication at least partially overlaps with the first portion of the communication.

23. The method of claim 15, further comprising:
detecting a setup failure for a unicast link on which the unicast transmission is to be conveyed; and
receiving the second portion of the communication via the unicast link after the setup failure, wherein the second portion of the communication is disjoint from the first portion of the communication.

24. The method of claim 15, further comprising:
obtaining the second portion of the communication from a broadcast multicast service center.

25. The method of claim 15, wherein the first operator and the second operator share a connection on a core network.

26. The method of claim 15, further comprising:
obtaining the communication from a content delivery network.

27. The method of claim 15, wherein the UE is subscribed to the second operator and not subscribed to the first operator.

28. An apparatus for wireless communication, comprising:
means for receiving, from a first base station associated with a first operator, a broadcast transmission conveying a first portion of a communication; and
means for receiving, without triggering a retransmission of the broadcast transmission, a second portion of the communication via a unicast transmission from a second base station associated with a second operator.

29. The apparatus of claim 28, further comprising:
means for detecting a failure of the broadcast transmission; and
means for transmitting, to the second base station, a scheduling request to trigger an initialization of a unicast link on which the unicast transmission is conveyed.

30-41. (canceled)

42. An apparatus associated with a second operator for wireless communication, comprising:
means for receiving, from a user equipment (UE) that received a first portion of a communication from a base station associated with a first operator via a broadcast transmission, information indicating a failure of the broadcast transmission; and
means for providing, without triggering a retransmission of the broadcast transmission, a second portion of the communication via a unicast transmission.

43-58. (canceled)
